(19) United States
(12) Patent Application Publication
(10) Pub. No.: US 2024/0012617 A1
(43) Pub. Date: Jan. 11, 2024

(54) RANDOM NUMBER TESTER AND RANDOM NUMBER TESTING METHOD

(71) Applicant: Sony Semiconductor Solutions Corporation, Kanagawa (JP)

(72) Inventor: Tadaaki Tanimoto, Kanagawa (JP)

(21) Appl. No.: 18/037,436

(22) PCT Filed: Nov. 11, 2021
(86) PCT No.: PCT/JP2021/041442

§ 371 Date: May 17, 2023

(30) Foreign Application Priority Data
Dec. 22, 2020 (JP) 2020-212640

(51) Int. Cl. G06F 7/58

(52) U.S. Cl. CPC G06F 7/582

(57) ABSTRACT

Random number testing is disclosed. In one example, a random number tester includes a register unit that stores a pseudorandom number sequence generated by a random number generator, a next-bit prediction unit that performs machine learning in a learning mode so as to receive a bit string of m bits in the pseudorandom number sequence stored in the register unit as an input, and, according to a predetermined machine learning algorithm, output a desired bit string including a predicted next bit, and a matching probability determination unit that makes, in a test mode, a pass/fail determination on a random number test on the basis of a matching probability based on a next bit following an m-bit bit string in a pseudorandom number sequence generated by the random number generator and of a predicted next bit output from a trained next-bit prediction unit.

### TECHNICAL FIELD

The technology according to the present disclosure relates to a random number tester and a random number testing method.

### BACKGROUND ART

Properties that a random number should satisfy include (1) randomness exhibited by a random numerical sequence without a statistical bias, (2) unpredictability in which a next number cannot be predicted from a past sequence, and (3) irreproducibility in which identical sequences cannot be reproduced.

Current computers generate numerical sequences with deterministic calculation, and thus cannot generate true random numbers. Instead, the current computers generate pseudorandom numbers with a sort of approximation method while performing deterministic calculation. That is, a pseudorandom number is a number included in a random number sequence according to a uniform distribution and an indistinguishable numerical sequence, which are generated by a deterministic calculation in polynomial time. An arithmetic device that generates such a pseudorandom number is generally referred to as a pseudorandom number generator or simply referred to as a random number generator. According to a predetermined random number testing method, the random number generator is subjected to a quality evaluation on capability of generating an available pseudorandom number sequence. The random number tester is a device that evaluates the quality of the random number generator by using the predetermined random number testing method.

For example, the following Patent Document 1 discloses a random number test circuit that achieves a new random number testing method obtained by improving a random number testing method called “FIPS140-2”.

Furthermore, in recent years, some pseudorandom number verification tools using a neural network have been proposed (Non-Patent Documents 1 to 2 below).

### CITATION LIST

### Patent Document

Patent Document 1: Japanese Patent Application Laid-Open No. 2007-164434

### Non-Patent Document

Non-Patent Document 1: Marcello De Bernardi, et al., “Pseudo-Random Number Generation Using Generative Adversarial Networks”, Joint European Conference on Machine Learning and Knowledge Discovery in Databases, September 2018

Non-Patent Document 2: Artem A. Maksutov, et al., “PRNG assessment tests based on neural networks”, 2018 IEEE Conference of Russian Young Researchers in Electrical and Electronic Engineering, IEEE, January 2018

### SUMMARY OF THE INVENTION

### Problems to be Solved by the Invention

A pseudorandom number having a cryptographically available (secure) property is referred to as a cryptographically secure pseudorandom number. That is, the cryptographically secure pseudorandom number has a property of having no algorithm that predicts, when a first x bit (x is an arbitrary positive number) is given, a value of an (x+1)th bit with a probability of exceeding ½ in a probabilistic polynomial-time calculation amount. Such a test as to whether or not a property of the cryptographically secure pseudorandom number is satisfied is referred to as a “next-bit prediction test”, but no valid testing method has been proposed so far. Actually, the random number test circuit described above is not premised on the next-bit prediction testing method, and none of the verification tools is sufficient as the next-bit prediction testing method.

Therefore, in view of the above-described problem, an object of the technology according to the present disclosure is to propose an approximative method of a next-bit prediction test as to whether or not a property of the cryptographically secure pseudorandom number is satisfied, and to provide a random number tester and random number testing method for achieving the approximative method.

### Solutions to Problems

The present technology for solving the above-described problem includes the following specific technical matters or features.

The present technology according to a certain aspect is a random number tester that performs a random number test on a random number generator on the basis of a pseudorandom number sequence generated by the random number generator. The random number tester includes a register unit that stores a pseudorandom number sequence generated by the random number generator, a next-bit prediction learning unit that performs machine learning in a learning mode so as to receive a bit string in (b₁, b₂, . . . , and bₘ) of m bits (m is an integer of 2 or more) in the pseudorandom number sequence stored in the register unit as an input, and, according to a predetermined machine learning algorithm, output m−k-bit (k is a number of −1 or more and less than m) bit strings out (bₖ₊₂, . . . , bₘ, and bₘ₊₁), each of which including a predicted next bit pred, and a matching probability determination unit that, in a test mode, calculates a matching probability on the basis of a next bit nxt following an m-bit bit string in in a pseudorandom number sequence generated by the random number generator and of a predicted next bit pred output from a trained the next-bit prediction unit subjected to the machine learning, and makes a pass/fail determination on a random number test on the basis of the matching probability that is calculated. Here, b₁, b₂, . . . , bₘ, and bₘ₊₁ are consecutive m+1 bit strings output from the random number generator, and bₘ₊₁ is a next bit nxt. Then, the next-bit prediction unit is configured to perform the machine learning in the learning mode with an m-bit bit string in as an input and the m−k-bit bit string out as ground-truth data. In particular, the input data and the ground-truth data are configured such that the generated bit string from the random number generator is shifted by 1 bit. That is, when one piece of input data is (b₁, b₂, . . . , and bₘ) and the ground-truth data is (bₖ₊₂, . . . bₘ, and bₘ₊₁), a second input data and ground-truth data are (b₂, b₃, . . . , bₘ₊₁) and (bₖ₊₃, . . , bₘ₊₁, and bₘ₊₂) , respectively.

Furthermore, the present technology according to a certain aspect is a random number testing method for performing a random number test on a random number generator on the basis of a pseudorandom number sequence generated by the random number generator. The random number testing method includes storing, in a register unit, a pseudorandom number sequence generated by the random number generator, performing control to enable operation in the learning mode, and performing, by a next-bit prediction unit, machine learning in the learning mode according to a predetermined machine learning algorithm so as to receive a bit string in of m bits (m is an integer of 2 or more) in the pseudorandom number sequence stored in the register unit as an input, and, according to a predetermined machine learning algorithm, output m−k-bit (k is a number of −1 or more and less than m) bit strings out, each of which including a predicted next bit pred. Then, there is further included performing the machine learning with an m−k-bit bit string out as ground-truth data, the m−k-bit bit string out including m−k−1 bits in a subsequent stage among m bits in an input bit string in, and a bit nxt next to the input bit string in. Here, when k=−1, the bit string out is a bit string obtained by connecting the next bit nxt of the bit string in to the input bit string in.

Furthermore, the random number testing method may further include performing control to enable operation in a test mode after the machine learning is performed, and in the test mode, calculating a matching probability on the basis of a next bit nxt following an m-bit bit string in in a pseudorandom number sequence generated by the random number generator and of a predicted next bit pred output from a trained next-bit prediction unit subjected to the machine learning, and making a pass/fail determination on a random number test on the basis of the matching probability that is calculated.

Note that, in the present specification and the like, a means does not simply mean a physical means, and includes a case where a function of the means is implemented by software. Furthermore, a function of one means may be implemented by two or more physical means, or functions of two or more means may be implemented by one physical means. Furthermore, a “system” refers to a logical assembly of a plurality of devices (or functional modules that implement specific functions), and it does not matter whether or not each device or each functional module is in a single housing.

Other technical features, objects, effects, or advantages according to the present technology will be clarified by the following embodiments described with reference to the accompanying drawings. The effects described herein are only examples, and the effects of the present specification are not limited to these effects. Additional effects may also be obtained.

### BRIEF DESCRIPTION OF DRAWINGS

FIG. 1 is a block diagram illustrating an example of a schematic configuration of a random number tester according to an embodiment of the present technology.

FIG. 2 is a block diagram illustrating an example of a configuration of a control unit of a random number tester according to an embodiment of the present technology.

FIG. 3 is a diagram for describing an example of a pseudorandom number sequence input to a random number tester according to an embodiment of the present technology.

FIG. 4 is a block diagram illustrating another example of a configuration of a next-bit prediction unit of a random number tester according to an embodiment of the present technology.

FIG. 5 is a diagram illustrating an example of a logic synthesis circuit that constitutes a next-bit prediction unit of a random number tester according to an embodiment of the present technology.

FIG. 6 is a block diagram illustrating an example of a configuration of a matching probability calculation unit of a random number tester according to an embodiment of the present technology.

FIG. 7A is a flowchart for describing an example of operation of a random number tester according to an embodiment of the present technology.

FIG. 7B is a flowchart for describing an example of operation of a random number tester according to an embodiment of the present technology.

FIG. 7C is a flowchart for describing an example of operation of a random number tester according to an embodiment of the present technology.

FIG. 8 is a block diagram illustrating an example of a schematic configuration of a random number tester according to an embodiment of the present technology.

FIG. 9 is a diagram for describing an example of an action selection table in an action selection unit of a random number tester according to an embodiment of the present technology.

FIG. 10 is a block diagram illustrating an example of a schematic configuration of a random number tester according to an embodiment of the present technology.

FIG. 11 is a flowchart for describing an example of operation of a random number tester according to an embodiment of the present technology.

FIG. 12 is a block diagram illustrating an example of a schematic configuration of a random number tester according to an embodiment of the present technology.

FIG. 13 is a block diagram illustrating an example of a schematic configuration of a random number tester according to an embodiment of the present technology.

FIG. 14 is a block diagram illustrating an example of a schematic configuration of a random number tester according to an embodiment of the present technology.

### MODES FOR CARRYING OUT THE INVENTION

Hereinafter, an embodiment of the present technology will be described with reference to the drawings. However, the embodiments described below are merely examples, and are not intended to exclude applications of various modifications and techniques that are not explicitly described below. The present technology can be implemented by various modifications (for example, combination of each embodiment, or the like) within the scope thereof. Furthermore, in the following description of the drawings, the same or similar parts are denoted by the same or similar reference signs. The drawings are merely schematic representations, and dimensions and ratios of the dimensions therein or the like do not necessarily match the actual ones. Parts having different dimensional relations or ratios different between the drawings may be included.

[First Embodiment]

The present disclosure describes technology of constructing, with machine learning, an inference model having a rule for predicting a next bit on the basis of a finite-length bit string generated by a random number generator, and determining that a certain bit string is not a random number (pseudorandom number) in a case where the inference model indicates that a matching probability of the bit string is not ½. In other words, no matter which inference model is used, it can be said that a bit string is a random number as long as a probability of the bit string matching a next bit is ½. Conversely, according to the present technology, in a case where a certain inference model is used, if a probability of a bit string matching a next bit is not ½, it is determined that the bit string is not a random number. A random number tester according to the present technology described below may be configured as hardware, software, and/or firmware as will be apparent to those skilled in the art.

(Description of Overall Configuration)

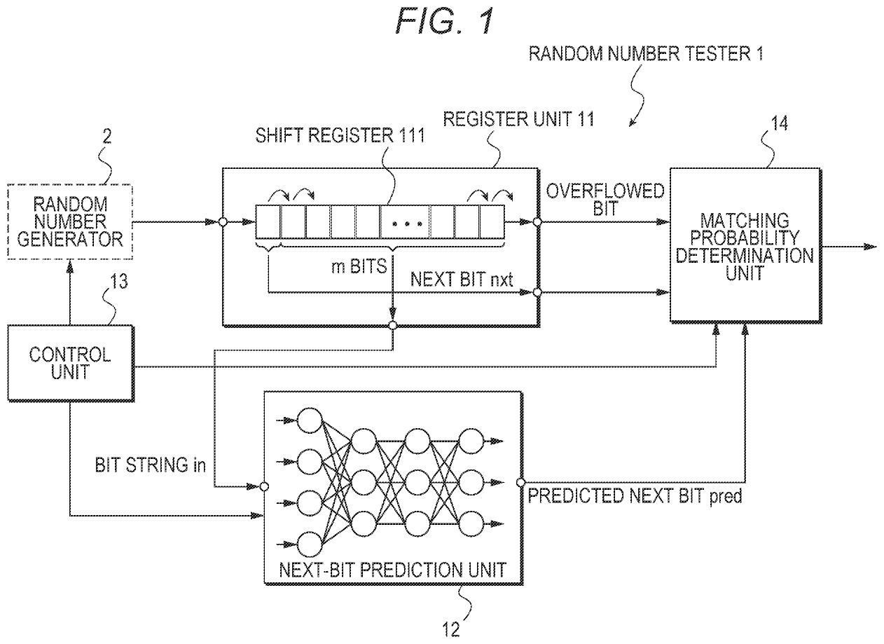

FIG. 1 is a block diagram illustrating an example of a schematic configuration of a random number tester according to an embodiment of the present technology. As illustrated in the figure, a random number tester 1 is functionally connected to a random number generator 2. The random number generator 2 repeatedly generates and outputs pseudorandom numbers including a bit string having a predetermined length (for example, 128 bits). That is, the random number generator 2 is a device to be subjected to a random number test by the random number tester 1. Hereinafter, a series of bit strings of pseudorandom numbers repeatedly generated and output by the random number generator 2 is referred to as a “pseudorandom number sequence”.

The random number tester 1 is a device that conducts a random number test on the random number generator 2. The random number test needs to be conducted within a range not exceeding an operation period (that is, a period in which identical bit strings are reproduced in the pseudorandom number sequence) of the random number generator 2, and the random number tester 1 according to the present disclosure is configured to be able to conduct such a test. The random number tester 1 includes, for example, a register unit 11, a next-bit prediction unit 12, a control unit 13, and a matching probability determination unit 14.

The register unit 11 temporarily stores pseudorandom number sequences sequentially input from the random number generator 2. The register unit 11 includes a shift register 111 that may perform shift operation on each bit in the pseudorandom number sequences. The register unit 11 outputs a specific bit or bit string while shifting the pseudorandom number sequences stored in the shift register 111 by 1 bit at a time at predetermined timings. For example, of a pseudorandom number sequence stored in the shift register 111, a bit string of m bits (m is an integer of 2 or more; 8 bits for example) from a predetermined bit position is output to the next-bit prediction unit 12, whereas a next 1 bit following the m-bit bit string (hereinafter, referred to as a “next bit nxt”) and a bit overflowed from the shift register 111 in response to the shift operation are output to the matching probability determination unit 14. Note that, hereinafter, the m-bit bit string that is input to the next-bit prediction unit 12 is referred to as a bit string in.

The next-bit prediction unit 12 predicts a bit that would have been generated next (hereinafter, referred to as a “predicted next bit pred”) following the bit string in in the pseudorandom number sequence generated by the random number generator 2. As will be described later, the predicted next bit pred that is predicted is compared with the next bit nxt following the bit string in in the pseudorandom number sequence, the next bit nxt actually being generated by the random number generator 2.

In the present disclosure, the next-bit prediction unit 12 is configured as a neural network model. As will be described later, in a learning (training) mode, the next-bit prediction unit 12 performs machine learning (also referred to as deep learning) according to a predetermined machine learning algorithm, on the basis of a bit string in in a pseudorandom number sequence (training data) generated by the random number generator 2 and of a next bit nxt that is a next bit of the bit string in, and is constructed as a trained inference model. The machine learning is repeatedly performed according to a training data quantity M to be described later, for example. In the present disclosure, the machine learning will be described taking classification as an example, but the present disclosure is not limited thereto, and for example, regression may also be applied as the machine learning. Furthermore, the machine learning may be ensemble learning. Then, in a test mode, the next-bit prediction unit 12 constructed as a trained inference model (hereinafter, may be simply referred to as a “trained next-bit prediction unit”) predicts the predicted next bit pred on the basis of the bit string in in the pseudorandom number sequence (test data) generated by the random number generator 2. In this case, the next-bit prediction unit 12 identifies, from among a 2^{m-k} (here, k is a number of −1 or more and less than m) number of m−k-bit bit-string candidates as a classification result, one bit string judged to have a statistical property most similar to a statistical property of the input bit string in, and outputs one bit in the identified bit string as the predicted next bit pred.

The control unit 13 sets an operation mode and comprehensively controls operation of the random number tester 1. For example, the control unit 13 performs control such that the next-bit prediction unit 12 operates in a learning mode, and selects a training data quantity M necessary for machine learning for the next-bit prediction unit 12. As the training data quantity M, an arbitrary number between a lower limit value M_{Min} and upper limit value M_{Max} of the training data quantity is selected. In the present disclosure, the lower limit value M_{Min} of the training data quantity is set to 2^{m+2} but is not limited thereto. Furthermore, the upper limit value M_{Max} is calculated, for example, on the basis of a predetermined sample quantity (sample size) S based on a predetermined reliability α and predetermined error δ that may ensure a sufficient random number test. For example, the upper limit value M_{Max} is calculated by obtaining a sample size necessary for a test of a finite population of the size S. The control unit 13 performs control so that the random number generator 2 repeatedly generates and outputs pseudorandom numbers (bit string having a predetermined length) corresponding to the decided training data quantity M. Alternatively, the control unit 13 stops the machine learning by the next-bit prediction unit 12 at a time point when the number of bits of the pseudorandom number sequence reaches the decided training data quantity M. For example, if the training data quantity M is 2000 and a bit length of each of the random numbers output from the pseudorandom number generator is 8 bits, 250 pseudorandom numbers are generated. After performing the machine learning on the next-bit prediction unit 12, the control unit 13 switches to the test mode and performs control such that the random number test is conducted on the random number generator 2.

In the test mode, the matching probability determination unit 14 sequentially compares a specific bit (that is, a next bit nxt following a bit string in) in the pseudorandom number sequence generated by the random number generator 2 with a predicted next bit pred output by the next-bit prediction unit 12, calculates a matching probability φ (or the number of matches) on the basis of a result of the comparison, and further, on the basis of the calculated matching probability φ, makes a pass/fail determination on whether the random number generator 2 passes or fails the random number test. For example, the matching probability determination unit 14 determines whether or not the matching probability φ calculated on the basis of the test falls within a range of the predetermined error δ, and, in a case where the matching probability φ is determined to be within the range of the predetermined error δ, outputs a random number test result indicating “passed”. Meanwhile, in a case where the matching probability φ is determined not to be within the range of the predetermined error δ, the matching probability determination unit 14 outputs a random number test result indicating “failed”.

Next, components, of the above-described components, particularly related to the present technology will be described. These components may be configured as hardware, software and/or firmware as will be apparent to those skilled in the art.

(Description of Control Unit)

The control unit 13 comprehensively controls operation of the random number tester 1. In particular, prior to the machine learning, the control unit 13 calculates an upper limit value M_{Max} of a quantity of training data necessary for the machine learning, and selects a training data quantity M in consideration of the calculated upper limit value M_{Max}. The control unit 13 operates the next-bit prediction unit 12 in the learning mode according to the selected training data quantity M.

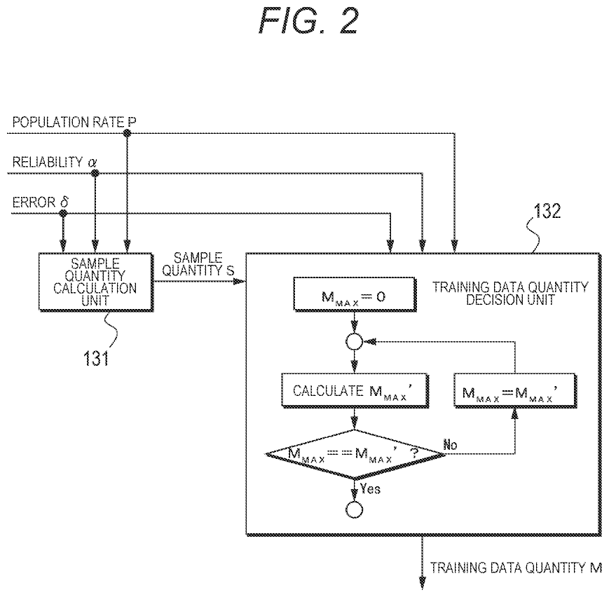

FIG. 2 is a block diagram illustrating an example of a configuration of a control unit of a random number tester according to an embodiment of the present technology. As illustrated in the figure, the control unit 13 includes a sample quantity calculation unit 131 and a training data quantity decision unit 132. Note that, in this example, the sample quantity calculation unit 131 and the training data quantity decision unit 132 are illustrated as a part of the control unit 13, but the present disclosure is not limited thereto, and the sample quantity calculation unit 131 and the training data quantity decision unit 132 may be configured separately from the control unit 13.

On the basis of a given population rate P_{M}, reliability α, and error δ, the sample quantity calculation unit 131 calculates a sample quantity S required for a test of the population rate P_{M}. Here, the population rate P_{M} is a probability that a certain event occurs, and in this example, the population rate P_{M} is 50%. The population rate P_{M} is equal to an expected value of a matching probability to be described later. Furthermore, the reliability o is a value (known as so-called σ) based on a probability density function of a statistical normal distribution for determining reliability of the random number test. Furthermore, the error δ is an allowable error with respect to the population rate P_{M}. The sample quantity S is calculated by a known method in statistics as will be apparent to those skilled in the art. Note that, because the training data and the test data are treated separately in the present embodiment, the upper limit value M_{Max} of the training data quantity is decided by calculating a quantity of samples necessary for the test in a case where sampling without replacement from the finite population is assumed, and by using the quantity of samples.

For example, assuming that the reliability α is 7σ, the necessary sample quantity S is 105845 when the error δ=5%, and is 2000 when the error δ=36.38%. Furthermore, assuming that the reliability α is 5σ, the necessary sample quantity S is 2504 bits when the error δ=5%, and is 2000 when the error δ=5.595%. Furthermore, assuming that the reliability αis 4.5σ, the necessary sample quantity S is 2026 when the error δ=5%, and is 2000 when the error δ=5.032%.

Now, with the population rate P_{M}=50%, the reliability α=5σ, and the error δ=5.072%, validity of the sample quantity S=2000 in the random number test is verified.

In this case, a null hypothesis H₀ and an alternative hypothesis H₁ are defined as below.
Null hypothesis H₀: in a finite population, a data group for which prediction of a next bit matches (ground-truth) accounts for 50% of the whole.
Alternative hypothesis H₁: in a finite population, a data group for which prediction of a next bit matches (ground-truth) does not account for 50% of the whole.

Therefore, as to the predicted matching probability φ of the next bit, when

50−5.595≤φ≤50+5.595 Formula 1
holds, the null hypothesis H₀ is rejected and the alternative hypothesis H₁ is accepted, whereas, when

φ<50−5.595Vφ>50+5.595 Formula 2

(where “V” is an operator that takes a smaller value)
holds, the null hypothesis H₀ is not rejected, and the null hypothesis H₀ is accepted.

The reliability α and the error σ described above are set so that a next-bit prediction test for a 2000-bit pseudorandom number sequence carries a significance.

In settings of the population rate P_{M}, the reliability α, and the error δ, the training data quantity decision unit 132 calculates the upper limit value M_{Max} of the training data quantity on the basis of a sample quantity S obtained from an infinite population, and selects the training data quantity M in consideration of the calculated upper limit value M_{Max}.

For example, the training data quantity decision unit 132 first sets the upper limit value M_{Max} to an initial value 0, and next, sets a population quantity N to S+M_{Max}, and acquires, as an upper limit value M_{Max}′, a next sample quantity M, which is the population rate P_{M}, reliability α, or error δ calculated by using the sample quantity calculation unit 131, necessary for a random number test. Subsequently, the training data quantity decision unit 132 judges whether or not a current upper limit value M_{Max} matches the calculated upper limit value M_{Max}′, and, in a case where it is judged that the upper limit values do not match, updates the current upper limit value M_{Max} with the calculated upper limit value M_{Max}′, updates the population size N as S+M_{Max} again, acquires the sample quantity S from the sample quantity calculation unit 131, and sets the sample quantity S as the upper limit value M_{Max}′. The training data quantity decision unit 132 repeats the above-described processing a certain number of times until the current upper limit value M_{Max} and the calculated upper limit value M_{Max}′ match (converge). In a case where the current upper limit value M_{Max} matches the calculated upper limit value M_{Max}′, the final upper limit value M_{Max} is obtained.

Note that, in a case where a result of the above-described processing does not show convergence even after the certain number of times of repeat, in this example, the training data quantity decision unit 132 sets a quantity corresponding to 10% of the first sample quantity S as the upper limit value M_{Max} of the training data quantity.

After calculating the upper limit value M_{Max} of a final training data quantity, the training data quantity decision unit 132 selects one value from among arbitrary values between the lower limit value M_{Min} and the upper limit value M_{Max}, and decides the selected value as the training data quantity M.

(Description of Next-Bit Prediction Unit)

The next-bit prediction unit 12 is configured as a neural network model that predicts the predicted next bit pred that would have been generated by the random number generator 2 and follows the bit string in in the pseudorandom number sequence. Although a known neural network model is applicable as the neural network model, in the present disclosure, the neural network model is configured with a multilayer perceptron (MPL) using a rectified linear unit (ReLU). Note that, in the figure, four node layers are exemplified, but the present disclosure is not limited thereto. Under control of the control unit 13, the next-bit prediction unit 12 may operate either in the learning mode in which the next-bit prediction unit 12 performs, according to a predetermined machine learning algorithm, machine learning for predicting a predicted next bit pred with respect to an input pseudorandom number sequence, or in the test mode in which, after machine learning, the next-bit prediction unit 12 predicts a predicted next bit pred with respect to an input pseudorandom number sequence and outputs the predicted next bit pred.

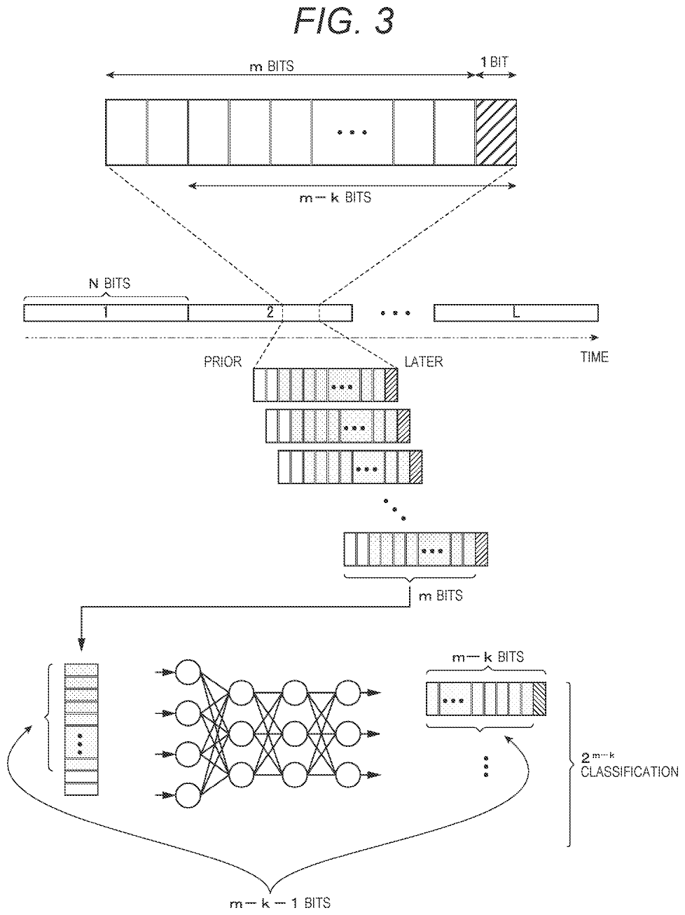

The next-bit prediction unit 12 includes a function that classifies an arbitrary bit string in in the pseudorandom number sequence output from the random number generator 2 into 2^{m-k}. Here, k is an arbitrary number that is −1 or more and m−1 or less. The function outputs, to the input bit string in, a bit string out including a predetermined bit string (prior m−k−1-bit bit string) in the bit string in, and a predicted next bit pred of 1 bit (later 1 bit) subsequent thereto (refer to FIG. 3). That is, the next-bit prediction unit 12 achieves resolution (classification) of 2^{m-k} pieces for prediction of the 1-bit predicted next bit pred, which is 0 or 1. For example, when k=−1, the bit string in is classified into 2^{m+1}. Note that, in the present disclosure, “prior” and “later” indicate a time sequence in a pseudorandom number sequence as a reference, and, in the time sequence, a “later” bit is positioned later in time than a “prior” bit.

FIG. 3 is a diagram for describing an example of a pseudorandom number sequence input to a random number tester according to an embodiment of the present technology. The random number generator 2 repeatedly outputs pseudorandom numbers of N bits (for example, N=128) according to the calculated training data quantity M. Therefore, the pseudorandom number sequence can be regarded as a bit string of N×L bits. For example, if the training data quantity M is 2000, the random number generator 2 generates a pseudorandom number sequence such that 2000+m bits are obtained. At least a part of such a pseudorandom number sequence is stored in the shift register 111 of the register unit 11.

The next-bit prediction unit 12 receives the bit string in of the pseudorandom number sequence stored in the shift register 111 as an input, and outputs an m−k-bit bit string out including the predicted next bit pred. That is, the respective bit strings in output in the shift register 111 by being shifted by 1 bit at a time are sequentially input to the next-bit prediction unit 12, and the next-bit prediction unit 12 outputs bit strings out.

In the learning mode, according to a predetermined machine learning algorithm, the next-bit prediction unit 12 finds a deviation in an appearance rate of the predicted next bit pred based on the statistical property, and performs machine learning on function approximation thereof. For the function approximation, for example, an approximation method of a one-dimensional Lipschitz continuous function can be used. That is, with respect to an input bit string in, an appearance rate of 0 or 1 in each bit in the pseudorandom number sequence is machine learned. In particular, in the present disclosure, the next-bit prediction unit 12 performs machine learning such that an output bit string out includes, with respect to the input bit string in, the prior m−k−1-bit bit string in the bit string in, in addition to the predicted next bit pred, and therefore, prediction of a predicted next bit pred in consideration of a value of the prior m−k−1 bits is achieved. Therefore, the next-bit prediction unit 12 obtained by the machine learning conducts a sufficient random number test according to an extremely high reliability α′ and a sufficiently small error δ′ and confirms rejection, thereby confirming that the rejection is not performed with practically required reliability α and error δ, and is constructed as a trained inference model that achieves a next-bit estimation probability of ½ with the practically required reliability α and error δ.

In the test mode, the next-bit prediction unit 12 constructed as the trained inference model calculates the predicted next bit pred predicted for each bit string in, on the basis of the pseudorandom number sequence (test data including an L number of pseudorandom numbers) generated by the random number generator 2. The number of bit strings in used for the test (test data quantity T) is determined by the practically required reliability α and error δ. In the test mode, the next-bit prediction unit 12 identifies, from among the output 2^{m-k} number of bit strings out, one bit string out judged to have a statistical property most similar to a statistical property of the input bit string in, and outputs the predicted next bit pred in the identified bit string out.

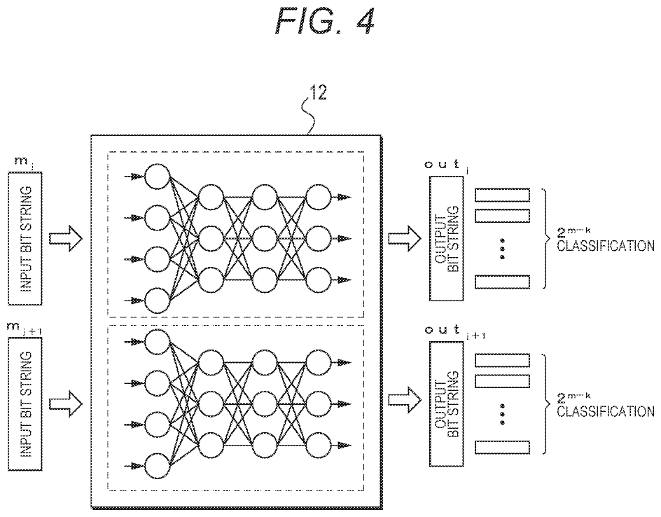

Note that, as a modification, the next-bit prediction unit 12 may be constructed, on the basis of a regularization technique, as an integrated neural network model in which at least two or more identical neural network models are disposed in parallel as illustrated in FIG. 4. An m-bit bit string (inⱼ and inⱼ₊₁) shifted by 1 bit is input to each of the neural network models in parallel. One m−k-bit bit string out, is output from among a 2^{m-k} number of candidates with respect to input of a bit string inⱼ, whereas one m−k-bit bit string outⱼ₊₁ is output from among the 2^{m-k} number of candidates with respect to input of a bit string inⱼ₊₁. That is, the next-bit prediction unit 12 is, because an output bit string includes the prior m−k−1 bits in the input bit string in, if mutual overlapping of such bit strings is in consideration, two outputs are overlapped by m−k−2 bits, and adds a regularization term that minimizes difference of a portion where these two outputs overlap, and performs machine learning with the neural network models in parallel as one neural network model. With this arrangement, so-called overtraining is avoided, and improvement in learning accuracy is expected.

(Hardware Implementation Example of Next-Bit Prediction Unit)

Here, an example of hardware implementation of the next-bit prediction unit 12 will be described. In the present disclosure, attention is paid to prediction of 1 bit with respect to the bit string in in the pseudorandom number sequence, and therefore, the next-bit prediction unit 12 is configured by implementing, in a hardware manner, a logic function based on a predetermined truth table (LUT) configured by using a binary logic circuit.

That is, the logic function outputs a logical value based on a truth table defined on the basis of the predicted next bit pred output with respect to the bit string in by the trained next-bit prediction unit 12 on which the machine learning has been performed. In creation of the truth table, for example, 2^{m} bit strings in are prepared in ascending order. More specifically, the respective 2^{m} bit strings in are sequentially input to the trained next-bit prediction unit 12 and predicted next bits pred are output, by which a truth table of the predicted next bits pred with respect to the bit string in are obtained. By executing such processing twice, two 2^{m} truth tables may be created, and further, the two truth tables may be sequentially compared and confirmed to be identical. The obtained truth table (logic function) is designed as a logic synthesis circuit by using, for example, a hardware description language such as Verilog-HDL.

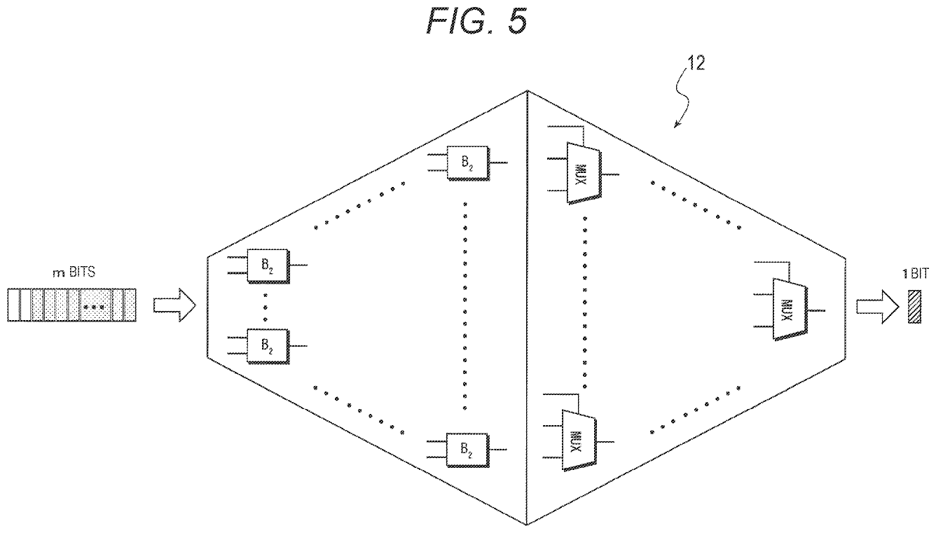

Each logic function turns into, for example, a logic synthesis circuit as illustrated in FIG. 5 by using a binary logic circuit of, for example, 16-way two-input, one-output LUT functions. In the figure, each bit of the bit string in is input to a binary logic circuit B₂ of an input stage, loaded into a network tree of the binary logic circuit B₂, and then converged in a network tree of a multiplexer MUX, by which the predicted next bit pred is output. The multiplexer MUX includes, for example, three binary logic circuits B₂.

For example, in a case where m=9, the logic function may be configured by an extremely small number of binary logic circuits, which is 2^{m}/m=2⁹/9=56 at maximum.

(Description of Matching Probability Determination Unit)

In the test mode, the matching probability determination unit 14 sequentially compares a last 1 bit (that is, a next bit nxt) in the pseudorandom number sequence generated by the random number generator 2 with a predicted next bit pred output by the next-bit prediction unit 12, and calculates a matching probability φ on the basis of a result of the comparison. Moreover, on the basis of the calculated matching probability φ, the matching probability determination unit 14 makes a determination on whether the random number generator 2 passes or fails the random number test.

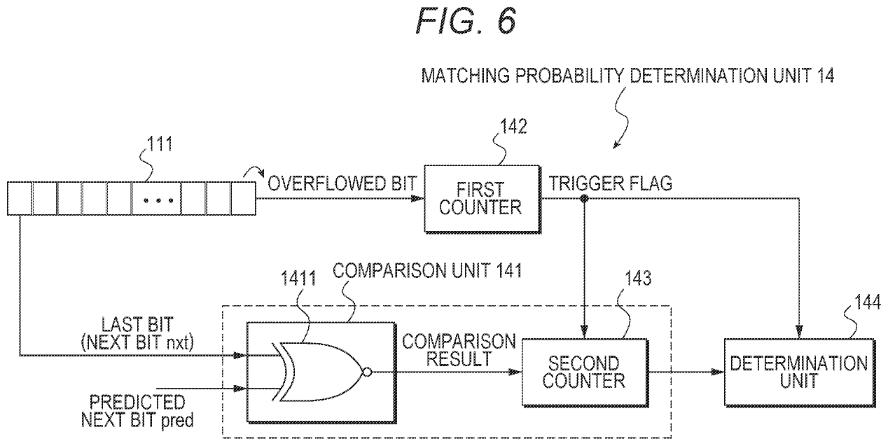

FIG. 6 is a block diagram illustrating an example of a configuration of a matching probability calculation unit of a random number tester according to an embodiment of the present technology. As illustrated in the figure, the matching probability determination unit 14 includes, for example, a comparison unit 141, a first counter 142, a second counter 143, and a determination unit 144.

The comparison unit 141 includes, for example, an XNOR logic circuit 1411. The comparison unit 141 performs an XNOR logic operation of a next bit nxt following a bit string in in a pseudorandom number sequence stored in the shift register 111, and a predicted next bit pred output by the next-bit prediction unit 12. That is, the comparison unit 141 outputs a logical value “1” in a case where the next bit nxt matches the predicted next bit pred.

The first counter 142 increments a held count value cnt1 each time 1 bit overflows from the shift register 111 due to shift operation of the shift register 111 of the register unit 11. That is, the first counter 142 counts the number of times the bit strings in are input to the next-bit prediction unit 12 (that is, the number of next bits that are output). When the count value cnt1 reaches a predetermined bit (for example, 2000 bits), the first counter 142 outputs a trigger flag to the determination unit 144 and the second counter 143, and initializes the count value cnt1 to “0”.

The second counter 143 increments and outputs a held count value cnt2 in a case where the output of the XNOR logic circuit 1411 is “1”. That is, the second counter 143 counts the number of times the next bit nxt matches the predicted next bit pred. Upon detecting the trigger flag from the first counter 142, the second counter 143 initializes the count value cnt2 to “0”.

Upon detecting the trigger flag from the first counter 142, at that time point, the determination unit 144 determines whether or not the count value cnt2 received from the second counter 143 is within a predetermined range, and outputs a result of the determination. In a case of having determined that the count value cnt2 is within the predetermined range, the determination unit 144 outputs a determination result indicating “passed”. Meanwhile, in a case of having determined that the count value cnt2 is within the predetermined range, the determination unit 144 outputs a determination result indicating “failed”.

That is, because the count value cnt2 indicates the number of times of matching between each next bit nxt in a pseudorandom number sequence and each predicted next bit pred corresponding thereto, a value obtained by dividing the count value cnt2 by the test data quantity T indicates a probability that both the bits match. Therefore, if the count value cnt2 indicates being a half of the test data quantity T, the pseudorandom number sequence is suitable as a cryptographically secure pseudorandom number. Meanwhile, because there is an actual problem that it is impossible to achieve a probability of ½ in a strict sense, a predetermined range in consideration of the error δ is defined, and whether or not the count value cnt2 is within the predetermined range is determined to determine suitability of the pseudorandom number sequence as a cryptographically secure pseudorandom number.

For example, consider a case where the test data quantity T required is 2000 where the reliability α=5σ and the error δ=5.595%. Because an expected matching probability φ is 50%, a maximum value and minimum value that define the range of the allowable number of times of matches (count value cnt2) are as follows.
Maximum value: 2000×(0.5+0.0595)=1119
Minimum value: 2000×(0.5−0.0595)≥881
That is, if the count value cnt2 is within the following range

881≤cnt2≤1119
then, the pseudorandom number sequence is suitable (that is, passed) as the cryptographically secure pseudorandom number.

(Description of Operation of Random Number Tester)

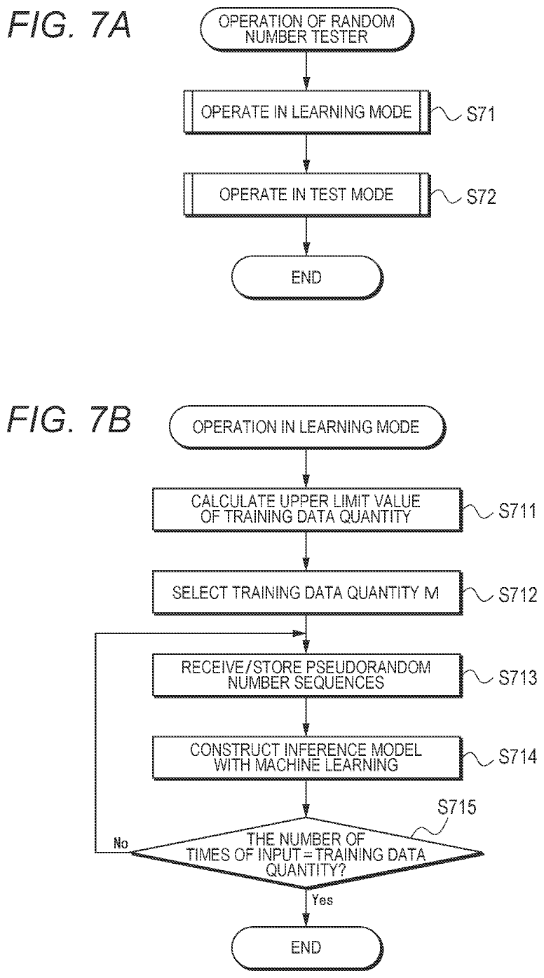

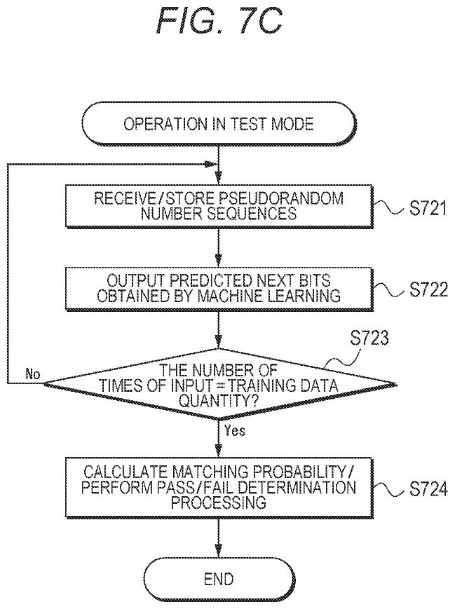

Next, operation of the random number tester 1 of the present embodiment will be described. FIGS. 7A to 7C are a flowcharts for describing examples of operation of a random number tester according to an embodiment of the present technology.

As illustrated in the figure A, under control of the control unit 13, the random number tester 1 first operates in the learning mode and performs machine learning on the next-bit prediction unit 12 by using the random number generator 2 (S71), and then operates in the test mode and conducts a random number test on the random number generator 2 by using the trained next-bit prediction unit 12 (S72). Hereinafter, each operation will be described with reference to FIGS. 7B and 7C.

FIG. 7B is a flowchart illustrating a detail of the operation in the learning mode illustrated in FIG. 7A (S71).

As illustrated in the figure B, the control unit 13 of the random number tester 1 sets the learning mode, calculates the upper limit value M_{Max} of the training data quantity on the basis of the population rate P_{M}, the reliability α, the error δ, and the sample quantity S (S711), and selects an arbitrary training data quantity M from between the lower limit value and the calculated upper limit value M_{Max} (S712).

Next, after starting to receive the pseudorandom number sequences from the random number generator 2, the random number tester 1 sequentially stores the pseudorandom number sequences in the shift register 111 of the register unit 11 (S713). With this arrangement, the next-bit prediction unit 12 performs machine learning according to a known machine learning algorithm on the basis of the bit string in output from the shift register 111 (S714).

The control unit 13 judges whether or not the number of times of input of the bit strings has reached the predetermined training data quantity M (S715), and, in a case of having determined that the number of times of input of the bit strings has not reached the predetermined training data quantity M (No in S715), causes the next-bit prediction unit 12 to perform further machine learning. Meanwhile, in a case of having judged that the number of times of input of the bit strings has reached the predetermined training data quantity M (Yes in S715) , the control unit 13 ends the learning mode.

FIG. 7C is a flowchart illustrating a detail of the operation in the test mode illustrated in FIG. 7A (S72).

As illustrated in the figure C, in the test mode, similarly, the random number tester 1 starts to receive the pseudorandom number sequences from the random number generator 2, and sequentially stores the pseudorandom number sequences in the shift register 111 of the register unit 11 (S721). With this arrangement, the next-bit prediction unit 12 outputs the predicted next bits pred on the basis of the bit strings in output from the shift register 111 (S722). The output predicted next bits pred are output to the matching probability determination unit 14. The matching probability determination unit 14 counts the number of times of input of the bit strings and counts the number of times of matching between the next bit nxt and the predicted next bit pred.

In a case of having judged that the number of times of input of the bit strings has reached the predetermined test data quantity TM (Yes in S723) , the matching probability determination unit 14 calculates the matching probability φ, and makes a pass/fail determination for the random number test on the basis of the calculated matching probability φ (S724). The matching probability φ is a value obtained by dividing the number of times the next bit nxt matches the predicted next bit pred corresponding thereto by the test data quantity T.

(Technical Effects or Advantages)

As described above, according to the present embodiment, in the learning mode, the next-bit prediction unit 12 performs machine learning such that the output bit string out includes, with respect to the input bit string in, a least significant m−k−1 bit in the bit string in as training data, and, immediately thereafter, includes the next bit nxt of the bit string in, and therefore, prediction of a predicted next bit pred in consideration of a value of the least significant m−k−1 bits is achieved.

[Second Embodiment]

The present embodiment is a modification of the first embodiment described above, and is characterized in that a predetermined action selection algorithm is applied to a random number tester. As the predetermined action selection algorithm, for example, an ε-Greedy method can be used, but the algorithm is not limited thereto. As an alternative method, for example, a KL-UCB policy or a Thompson sampling method may be used.

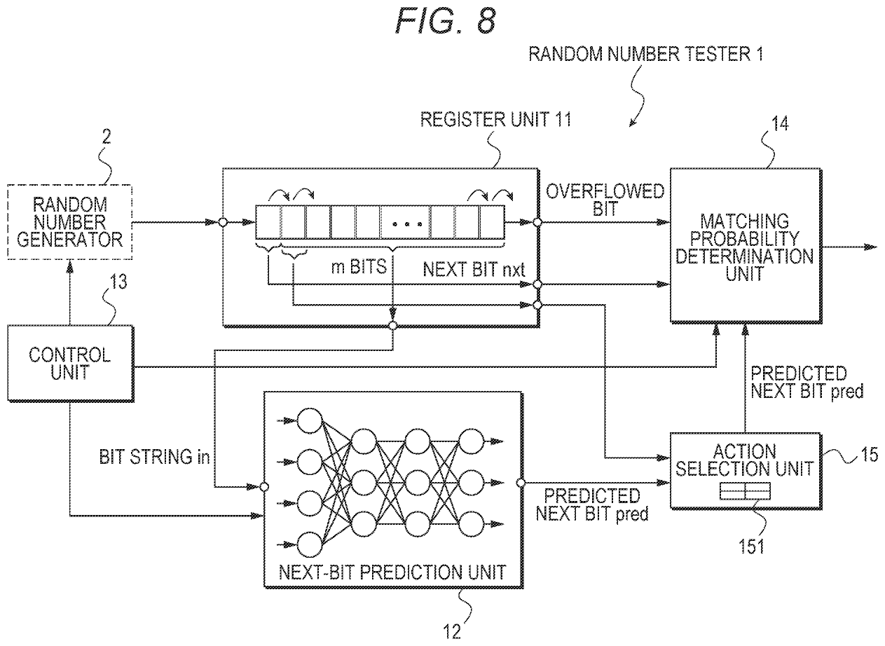

FIG. 8 is a block diagram illustrating an example of a schematic configuration of a random number tester according to an embodiment of the present technology. As illustrated in the figure, a random number tester 1 includes, for example, a register unit 11, a next-bit prediction unit 12, a control unit 13, a matching probability determination unit 14, and an action selection unit 15. That is, the random number tester 1 according to the present embodiment is different from the random number tester 1 according to the above-described embodiment in that the action selection unit 15 is additionally provided. Note that, in the drawings, components the same as the components described in the above-described embodiment are denoted by the same reference signs, and description thereof is appropriately omitted.

In the present embodiment, in addition to the above-described configuration, the register unit 11 is configured to output a bit immediately before a next bit nxt in a pseudorandom number sequence stored in a shift register 111.

The action selection unit 15 includes an action selection table 151 defining an expected value Pᵣ of a conditional probability, obtains a corrected bit value from the action selection table 151 on the basis of a predicted next bit pred output from the next-bit prediction unit 12, and outputs the corrected bit value as a corrected predicted next bit pred. In a test mode, the action selection unit 15 outputs the predicted next bit pred to the matching probability determination unit 14, and, as in the above-described embodiment, the matching probability determination unit 14 calculates a matching probability φ on the basis of the predicted next bit pred and makes a pass/fail determination. Furthermore, after outputting the predicted next bit pred, the action selection unit 15 updates the expected value Pᵣ of the conditional probability in the action selection table 151 by using the bit immediately before the next bit nxt.

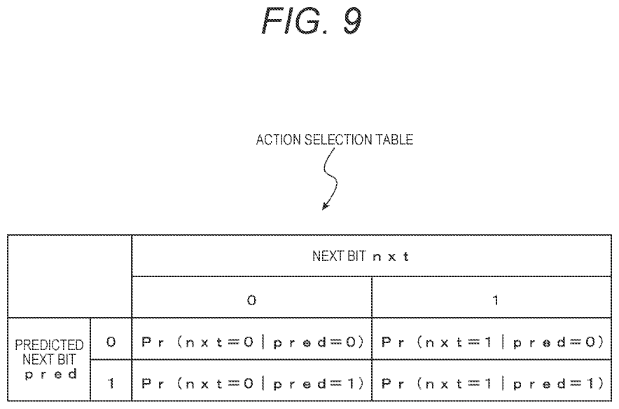

FIG. 9 is a diagram for describing an example of the action selection table 151 in an action selection unit of a random number tester according to an embodiment of the present technology. In the action selection table 151 illustrated in the figure, for example, “Pᵣ (nxt=0|pred=0)” indicates an expected value Pᵣ of a probability that a value of a next bit nxt given from the shift register 111 is “0” under a condition that a value of a next bit pred given from the next-bit prediction unit 12 is “0”. The expected value Pᵣ of the conditional probability is sequentially updated by using the bit immediately before the next bit nxt, which is a ground truth case. In other words, the action selection table 151 indicates the predicted next bit pred depending on a past history (pseudorandom number sequence). That is, the past history is learned by update of a conditional matching probability between the immediately preceding predicted next bit pred and the next bit nxt, and a current predicted next bit pred is dynamically corrected. The expected value Pᵣ of the conditional probability in the action selection table 151 is initialized with a probability of ½ prior to operation of the random number tester 1.

For example, upon receiving the predicted next bit pred from the next-bit prediction unit 12, the action selection unit 15 refers to the action selection table 151 and outputs the value of the next bit nxt having a maximum (or minimum) expected value Pᵣ as the predicted next bit pred. Alternatively, the action selection unit 15 may refer to the action selection table 151, and, in a case where a difference between a maximum value and minimum value of the expected value Pᵣ exceeds a predetermined threshold value, may output the value of the next bit nxt having a maximum (or minimum) expected value Pᵣ as the predicted next bit pred.

Furthermore, before outputting the predicted next bit pred, the action selection unit 15 updates, by using the bit immediately before the next bit nxt and immediately preceding previous predicted next bit pred in the shift register 111, the expected value Pᵣ of the conditional probability corresponding to the predicted next bit pred output by the next-bit prediction unit 12 in the action selection table 151. In a learning mode and/or the test mode, the action selection unit 15 updates the expected value Pᵣ of the conditional probability in the action selection table 151.

(Technical Effects or Advantages)

As described above, according to the present embodiment, the random number tester 1 applies the action selection algorithm to a next bit pred output by the next-bit prediction unit 12, and therefore accuracy of the random number test can be further improved. In particular, according to the present embodiment, the random number tester 1 includes the action selection unit 15 including the action selection table 151 defining the expected value Pᵣ of the conditional probability, and, according to the action selection table 151, the action selection unit 15 can correct the predicted next bit pred output by the next-bit prediction unit 12 into a predicted next bit pred having a higher expected value. Furthermore, because the action selection unit 15 dynamically updates the expected value Pᵣ of the conditional probability on the basis of the past pseudorandom number sequence, the accuracy of correction can be improved.

[Third Embodiment]

The present embodiment is a modification of the above-described embodiment, and is characterized in that a predetermined Bayesian hypothesis testing method is applied to a random number test by a random number tester. Here, a description will be given on the basis of the second embodiment to which an action selection algorithm is applied, but the present disclosure is not limited thereto.

As described above, because a sample quantity S is calculated on the basis of a population rate P_{M}, a reliability α, and an error rate δ, a sample quantity S generally tends to increase. Meanwhile, because if sufficient posterior reliability can be obtained, a random number test carries a significance. Therefore, if there is a sufficient number of sample quantity S to achieve a posterior reliability, the random number test can be accomplished. Therefore, in order to determine such a sample quantity S, the Bayesian hypothesis testing method is utilized.

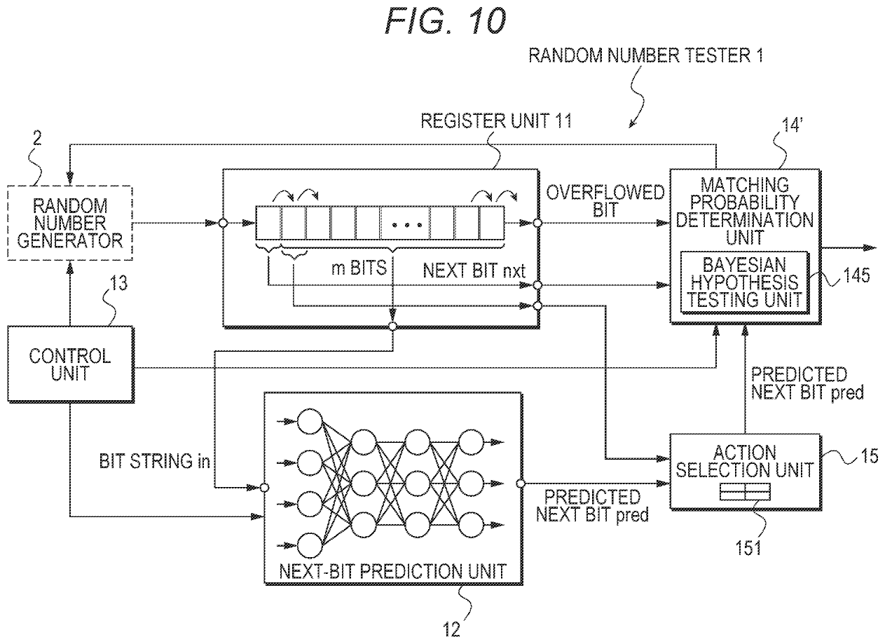

FIG. 10 is a block diagram illustrating an example of a schematic configuration of a random number tester according to an embodiment of the present technology. Note that, in the drawings, components the same as the components described in the above-described embodiment are denoted by the same reference signs, and description thereof is appropriately omitted (hereinafter the same).

As illustrated in the figure, a random number tester 1 according to the present embodiment includes a matching probability determination unit 14′ that is a modification of the matching probability determination unit 14 described above. The matching probability determination unit 14′ includes a Bayesian hypothesis testing unit 145 that calculates a Bayes' factor BF and determines whether or not to accept a null hypothesis H₀ or an alternative hypothesis H₁ on the basis of the calculated Bayes' factor BF. The matching probability determination unit 14′ limits a test data quantity T generated by a random number generator 2 depending on a determination by the Bayesian hypothesis testing unit 145 on the acceptance, makes a pass/fail determination on the random number test, and ends the processing. That is, the matching probability determination unit 14′ determines, on the basis of the calculated Bayes' factor BF and a predetermined threshold value TH, whether the null hypothesis H₀ or the alternative hypothesis H₁ can be accepted, and, on the basis of a result of the determination, makes a pass/fail determination on the random number test. The predetermined threshold value TH is, for example, a half a value of a training data quantity M.

In the present embodiment, the null hypothesis H₀ and the alternative hypothesis H₁ are defined as a one-tailed test as below.
Null hypothesis H₀ (φ≥0): Matching probability φ (probability that next bit nxt=predicted next bit pred holds) is equal to or greater than θ. Here, θ=0.5−ε, and ε is an arbitrary number (ε=0.05, for example).
Alternative hypothesis H₁ (φ<θ): Matching probability φ (probability that next bit nxt=predicted next bit pred holds) is less than θ. Here, θ=0.5−ε, and ε is an arbitrary number (ε=0.05, for example).

Furthermore, a hypothesis may be defined as follows.
Null hypothesis H₀ (φ≤θ): Matching probability φ (probability that next bit nxt=predicted next bit pred holds) is equal to or greater than θ. Here, θ=0.5+ε, and ε is an arbitrary number (ε=0.05, for example).
Alternative hypothesis H₁ (φ>θ): Matching probability φ (probability that next bit nxt=predicted next bit pred holds) is less than θ. Here, θ=0.5+ε, and ε is an arbitrary number (ε=0.05, for example).

For both of the two described above, H₀ (φ≥θ)+H₁ (φ<θ)=1 holds.

Furthermore, the Bayes' factor BF is known to be obtained by the following Mathematical Formula (P. Zuliani, A. Platzer, and E. M. Clarke, “Bayesian Statistical Model Checking with Ap) plication to Stateflow/Simulink Verification” In Proc. of HSCC, pp. 243-252, 2010).

$$\begin{matrix}[ Mathematical Formula 1 ] & \\ BF ( n , x , θ , α , β ) := \frac{1 - {π}_{0}}{{π}_{0}} \times ( \frac{1}{{F}_{( x + α , n - x + β )} ( θ )} - 1 ) & Formula 3\end{matrix}$$

Here,

[Mathematical Formula 2]

π₀=∫_{θ}¹g(u)du Formula 4

where g is a density function of a beta distribution, F is a beta distribution function, and α and β (>0) are shape generatrix parameters in the beta distribution. Furthermore, n is the number of times of inputs (that is, the above-described count value cnt1), and x is the number of matches (that is, the above-described count value cnt2) between the next bit nxt and the predicted next bit pred.

In a case where the calculated Bayes' factor BF is larger than the predetermined threshold value TH, the Bayesian hypothesis testing unit 145 rejects the null hypothesis H₀, and therefore, determines that the random number test results in “failed”. Furthermore, in a case where the calculated Bayes' factor BF is smaller than a reciprocal of the predetermined threshold value TH (that is, 1/TH), the Bayesian hypothesis testing unit 145 rejects the alternative hypothesis H₁, and therefore, determines that the random number test results in “passed”. Meanwhile, in a case where the calculated Bayes' factor BF is not larger than the predetermined threshold value TH and is smaller than the reciprocal of the predetermined threshold value TH, in order to further obtain predicted next bits pred output by a next-bit prediction unit 12, control is performed so that the random number generator 2 continuously generates pseudorandom number sequences.

(Description of Operation of Random Number Tester)

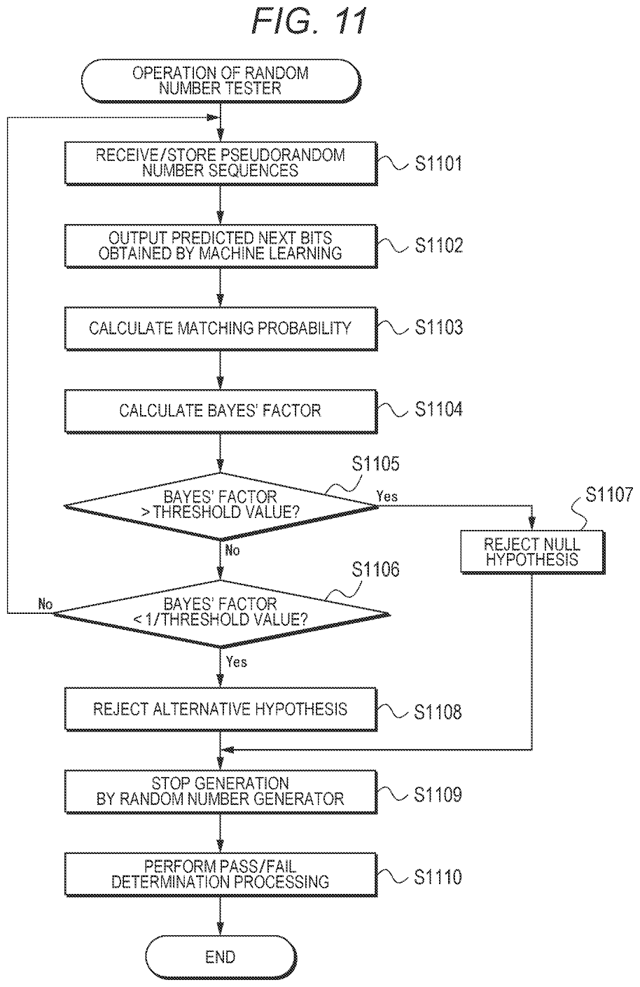

Next, operation of the random number tester 1 of the present embodiment will be described. FIG. 11 is a flowchart for describing an example of operation of a random number tester according to an embodiment of the present technology. Note that the figure describes operation of the random number tester 1 in a test mode after the next-bit prediction unit 12 is subjected to machine learning in a learning mode.

As illustrated in the figure, in the test mode, similarly, the random number tester 1 starts to receive the pseudorandom number sequences from the random number generator 2, and sequentially stores the pseudorandom number sequences in the shift register 111 of the register unit 11 (S1101). With this arrangement, the next-bit prediction unit 12 outputs the predicted next bits pred on the basis of bit strings in output from the shift register 111 (S1102). The output predicted next bits pred are output to the matching probability determination unit 14′.

The matching probability determination unit 14′ counts the number of times of input of the bit strings and counts the number of times of matching between the next bit nxt and the predicted next bit pred, thereby calculating the matching probability φ (S1103). Next, the matching probability determination unit 14′ calculates the Bayes' factor BF according to the above-described Formula 1 (S1104).

The matching probability determination unit 14′ judges whether or not the calculated Bayes' factor BF exceeds the predetermined threshold value TH (S1105). In a case of having judged that the Bayes' factor BF does not exceed the predetermined threshold value TH (No in S1105), the matching probability determination unit 14′ subsequently judges whether or not the calculated Bayes' factor BF is smaller than the reciprocal of the predetermined threshold value TH (that is, 1/TH) (S1106).

In a case of having judged that the Bayes' factor BF is not smaller than the reciprocal of the predetermined threshold value TH (No in S1106), the matching probability determination unit 14′ returns to the processing in S1101 in order to further obtain a predicted next bit pred output by the next-bit prediction unit 12. That is, the random number tester 1 judges that the test data quantity T is not sufficient to reject the null hypothesis H₀ or the alternative hypothesis H₁, and continues prediction with the next-bit prediction unit 12.

Meanwhile, in a case of having judged that the Bayes' factor BF exceeds the predetermined threshold value TH (Yes in S1105), the matching probability determination unit 14 rejects the null hypothesis H₀ (S1107), and performs control to stop the generation of the pseudorandom number sequences by the random number generator 2 (S1109).

Furthermore, in a case of having determined that the Bayes' factor BF is smaller than the reciprocal of the predetermined threshold value TH (Yes in S1106), the matching probability determination unit 14′ rejects the alternative hypothesis H₁ (S1107), and performs control to stop the generation of the pseudorandom number sequences by the random number generator 2 (S1109).

Next, the matching probability determination unit 14′ makes a pass/fail determination on the random number test on the basis of the rejection of the null hypothesis H₀or the alternative hypothesis H₁ (S1110).

(Technical Effects or Advantages)

As described above, according to the present embodiment, the random number tester 1 uses the test data quantity T sufficient to achieve the posterior reliability by the Bayesian hypothesis testing method, and therefore, the test data quantity T can be reduced. Furthermore, the random number tester 1 can conduct the random number test with so-called “on-the-fly execution”. Therefore, the random number tester 1 can conduct the random number test at a higher speed, and can save resources such as processor power and a memory size. Furthermore, the random number tester 1 can conduct the random number test with so-called “on-the-fly execution”.

[Fourth Embodiment]

The present embodiment is a modification of the above-described embodiment, and describes a random number tester that enables a random number test on a cryptographically secure pseudorandom number generator capable of setting a key value. That is, the random number tester according to the present embodiment is characterized in that a plurality of trained inference models for a pseudorandom number sequence generated for each key value is constructed, and predicted next bits based on the trained inference models are used.

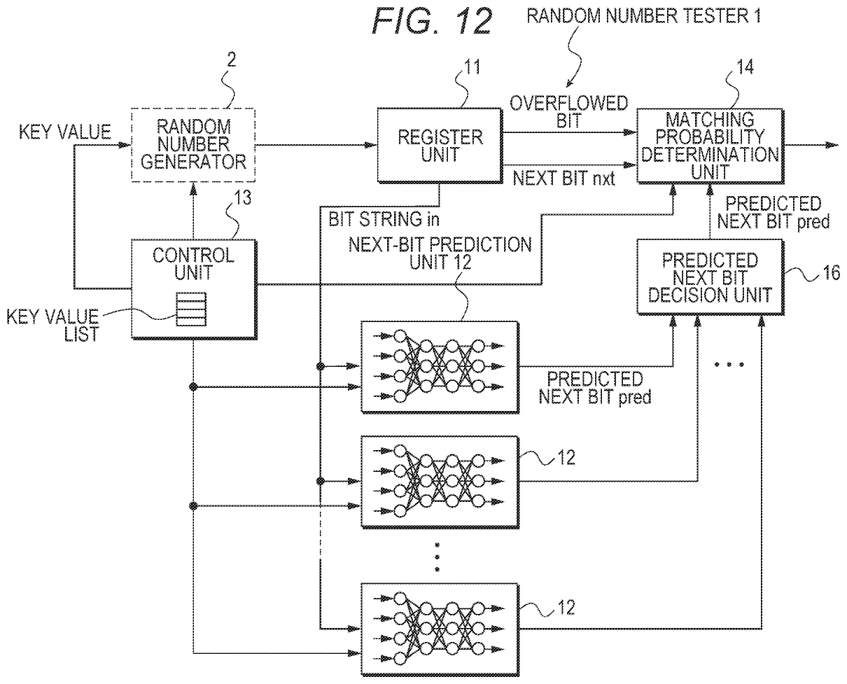

FIG. 12 is a block diagram illustrating an example of a schematic configuration of a random number tester according to an embodiment of the present technology. As illustrated in the figure, a random number tester 1 according to the present embodiment is different from the random number tester 1 according to the first embodiment in that a plurality of next-bit prediction units 12 is prepared and a predicted next bit decision unit 16 is further provided. Note that, in the drawings, components the same as the components described in the above-described embodiment are denoted by the same reference signs, and description thereof is appropriately omitted.

In the present embodiment, a random number generator 2 generates a pseudorandom number sequence on the basis of a given key value. The random number generator 2 is, for example, a cryptographically secure pseudorandom number generator having a block cipher mode of operation, such as AES-CTR, CTR_DRBG, or HAMC_DRBG, and can set a key value. In this example, some key values are input from a control unit 13 to the random number generator 2.

The control unit 13 holds, for example, a plurality of key values corresponding to the number of key values Keynum. The held key values are used in each of a learning mode and a test mode. Each of the key values may be, for example, an arbitrary numerical value or may be based on a pseudorandom number generated by the random number generator 2. For each of the key values, the control unit 13 calculates an upper limit value M_{Max} of a training data quantity, and selects an arbitrary number between a lower limit value M_{Min} of the training data quantity and the upper limit value M_{Max} of the training data quantity as a training data quantity M. The control unit 13 inputs the key values to the random number generator 2, and performs control such that the random number generator 2 repeatedly generates and outputs pseudorandom numbers by the selected training data quantity M.

The next-bit prediction units 12 are provided as many as the number of the key values. That is, under control of the control unit 13, in the learning mode, each of the plurality of next-bit prediction units 12 performs machine learning on the basis of the pseudorandom number sequences generated by the random number generator 2 for each set key value, and is constructed as a trained inference model. Then, in the test mode, each of the trained next-bit prediction units 12 outputs a predicted next bit pred to the predicted next bit decision unit 16 on the basis of the pseudorandom number sequences generated by the random number generator 2 according to the corresponding key value.

The predicted next bit decision unit 16 decides one predicted next bit pred on the basis of the predicted next bits pred output from the respective next-bit prediction units 12. Specifically, the predicted next bit decision unit 16 decides, by majority decision for example, one predicted next bit pred having either one value (that is, 0 or 1) from among values of the predicted next bits pred output from the respective next-bit prediction units 12. The predicted next bit decision unit 16 outputs the decided predicted next bit pred to a matching probability determination unit 14.

As described above, the matching probability determination unit 14 calculates a matching probability on the basis of the predicted next bit pred, and further makes a pass/fail determination on the random number test on the basis of the calculated matching probability.

As described above, according to the present embodiment, the random number tester 1 can also conduct a random number test on a random number generator capable of setting a key value. In particular, according to the present embodiment, each of the plurality of next-bit prediction units 12 performs machine learning according to a pseudorandom number sequence generated for each set key value, and accordingly, a predicted next bit pred is decided from among the predicted next bits pred output by the respective trained next-bit prediction units 12 by majority decision, and therefore, prediction with higher accuracy is possible.

[Fifth Embodiment]

The present embodiment is a modification of the above-described fourth embodiment, and is characterized in that an action selection algorithm is further applied to a random number test for a cryptographically secure pseudorandom number generator capable of setting a key value.

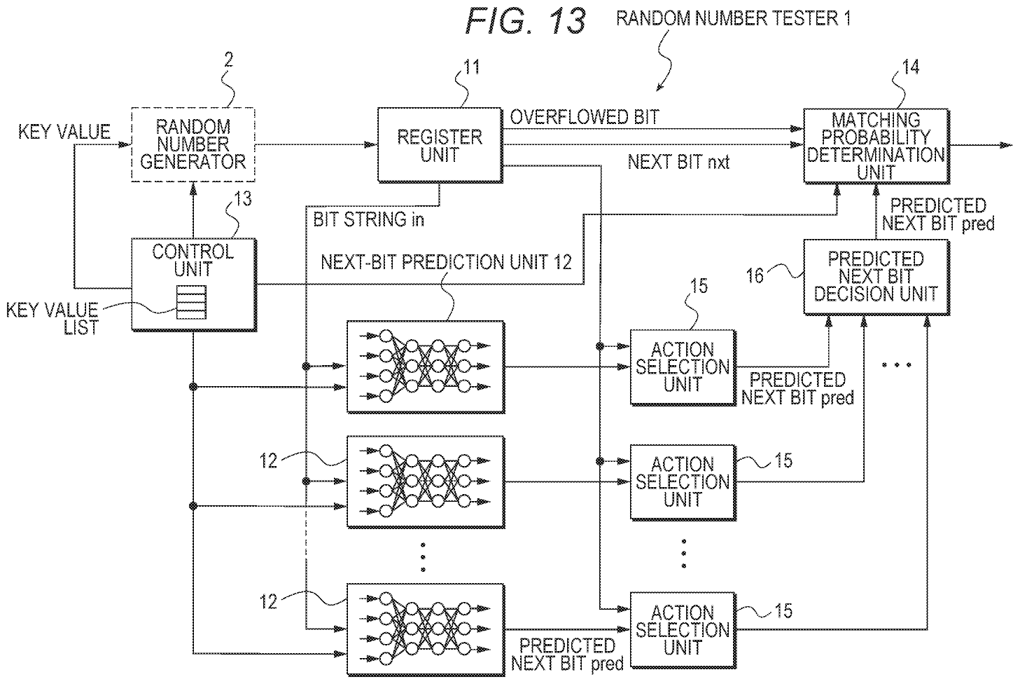

FIG. 13 is a block diagram illustrating an example of a schematic configuration of a random number tester according to an embodiment of the present technology. As illustrated in the figure, a random number tester 1 according to the present embodiment is different from the random number tester 1 according to the fourth embodiment in that action selection units 15 corresponding to respective next-bit prediction units 12 are further provided. Note that, in the drawings, components the same as the components described in the above-described embodiment are denoted by the same reference signs, and description thereof is appropriately omitted.

As described above, under control of a control unit 13, in a learning mode, each of the plurality of next-bit prediction units 12 performs machine learning on the basis of pseudorandom number sequences generated by a random number generator 2 for each set key value, and, in the test mode, on the basis of the pseudorandom number sequences generated by the random number generator 2 according to corresponding key values, the respective trained next-bit prediction units 12 output predicted next bits pred to a predicted next bit decision unit 16.

Furthermore, as described above, each of the action selection units 15 includes an action selection table 151 defining an expected value Pᵣ of a conditional probability, and outputs, on the basis of a predicted next bit pred output from the next-bit prediction unit 12, a corrected predicted next bit pred identified from the action selection table 151.

The predicted next bit decision unit 16 decides, by majority decision for example, one predicted next bit pred having any one value from among values of the predicted next bits pred output from the respective action selection units 15. The predicted next bit decision unit 16 outputs the decided predicted next bit pred to a matching probability determination unit 14.

As described above, the matching probability determination unit 14 calculates a matching probability on the basis of the predicted next bit pred, and further makes a pass/fail determination on the random number test on the basis of the calculated matching probability.

As described above, according to the present embodiment, the random number tester 1 can also conduct a random number test on a random number generator capable of setting a key value. In particular, according to the present embodiment, the action selection units 15 correct, according to the respective action selection tables 151, the predicted next bits pred output by the next-bit prediction unit 12 into next bits pred' having a higher expected value, and further, decide one predicted next bit pred from among them, and calculate the matching probability on the basis of this, and therefore, a random number test can be determined with higher accuracy.

Note that, as described in the third embodiment, a Bayesian hypothesis testing method may be further applied to the random number tester 1.

[Sixth Embodiment]

The present embodiment is a modification of the above-described embodiment, and is characterized in that, in a learning mode, a trained inference model is constructed pm the basis of one pseudorandom number sequence obtained by combining pseudorandom number sequences for each key value, by which, in a test mode, a trained inference model predicts a next bit on the basis of the one pseudorandom number sequence obtained by combining pseudorandom number sequences for each key value, and makes a determination on a random number test.

FIG. 13 is a block diagram illustrating an example of a schematic configuration of a random number tester according to an embodiment of the present technology. As illustrated in the figure, a random number tester 1 according to the present embodiment has a configuration basically the same as a configuration of the random number tester 1 according to the first embodiment, and is different from the configuration of the random number tester 1 according to the first embodiment in that pseudorandom number sequences generated for each key value by a random number generator 2 are output to a register unit 11 as one pseudorandom number sequence. That is, in the present embodiment, by treating the pseudorandom number sequences generated for each key value as one pseudorandom number sequence, a next-bit prediction unit 12 is configured to become one.

In the present embodiment, a control unit 13 determines a sample quantity S′ for calculating an upper limit value M_{Max} of a training data quantity depending on the number of key values Keynum. For example, the control unit 13 determines, as the sample quantity S′, an integer value based on a value obtained by dividing a sample quantity S calculated on the basis of a given population rate P_{M}, a reliability α, and error δ by the number of key values Keynum. The integer value is calculated by using, for example, a Ceil function. The control unit 13 calculates the upper limit value M_{Max} of the training data quantity on the basis of the calculated sample quantity S′, and further selects a training data quantity M.

In the learning mode, according to a set key value, the random number generator 2 outputs the training data by the selected training data quantity M, and accordingly, the random number tester 1 performs machine learning of the next-bit prediction unit 12. Furthermore, in the test mode, according to the set key value, the random number generator 2 outputs test data as many pieces as that, and accordingly, the random number tester 1 makes a pass/fail determination on the random number test on the basis of a predicted next bit pred output by the next-bit prediction unit 12.

As described above, according to the present embodiment, by treating the pseudorandom number sequences generated for respective key values as one pseudorandom number sequence, the random number tester 1 is configured by one next-bit prediction unit 12, whereas, similarly, a pass/fail determination on the random number test can be made.

Note that, as described in the above-described embodiment, an action selection algorithm and/or a Bayesian hypothesis testing method may be applied to the random number tester 1. Furthermore, a plurality of next-bit prediction units 12 corresponding to pseudorandom number sequences for each operation condition may be used without combining the pseudorandom number sequences generated for the respective key values into one.

[Seventh Embodiment]

The present embodiment is a modification of the above-described embodiment, and is characterized in that, in a learning mode, a trained inference model is constructed on the basis of a random number sequence configured by using output noise or the like by a ring oscillator or a digital-to-analog converter (A/D converter), the output noise or the like being generated for each of various operation conditions with different temperatures, voltages, or the like, and accordingly, in a test mode, a trained inference model predicts a next bit on the basis of a random number sequence generated for each of the various operation conditions, and makes a determination on a random number test.

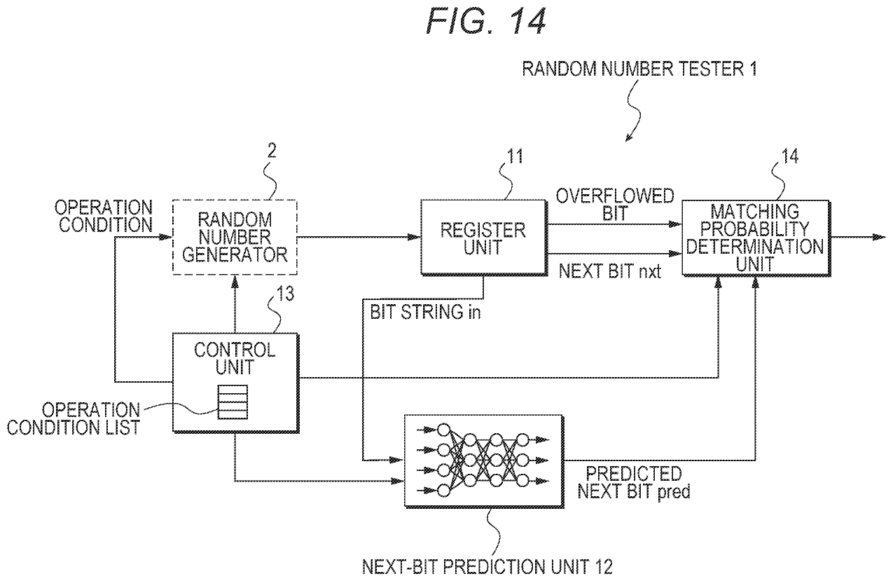

FIG. 14 is a block diagram illustrating an example of a schematic configuration of a random number tester according to an embodiment of the present technology. As illustrated in the figure, a random number tester 1 according to the present embodiment has a configuration basically the same as the configuration of the random number tester 1 described in the sixth embodiment, which is based on the first embodiment.

That is, as illustrated in the figure, a control unit 13 holds a plurality of operation conditions defining operating environment of a random number generator 2. The operation condition may be, for example, a combination of temperature, voltage, and the like. The control unit 13 determines a sample quantity S′ for calculating an upper limit value M_{Max} of a training data quantity depending on the number of operation conditions Condnum. For example, the control unit 13 determines, as the sample quantity S′, an integer value based on a value obtained by dividing a sample quantity S calculated on the basis of a given population rate P_{M}, reliability α, and error δ by the number of operation conditions Condnum. The integer value is calculated by using, for example, a Ceil function. The control unit 13 calculates the upper limit value M_{Max} of the training data quantity on the basis of the calculated sample quantity S′, and further selects a training data quantity M.

In the learning mode, according to the given operation conditions, the random number generator 2 outputs training data by the selected training data quantity M, and accordingly, the random number tester 1 performs machine learning of a next-bit prediction unit 12. Furthermore, in the test mode, according to the given operation conditions, the random number generator 2 outputs test data as many pieces as that, and accordingly, the random number tester 1 makes a pass/fail determination on the random number test on the basis of a predicted next bit pred output by the next-bit prediction unit 12.

As described above, according to the present embodiment, the trained inference model is constructed on the basis of the random number sequence generated according to various operation conditions, by which the trained inference model predicts a next bit on the basis of the random number sequence generated for each of the various operation conditions, and therefore, a random number test can be conducted under a condition closer to an actual operating environment.

Note that, as described in the above-described embodiment, an action selection algorithm and/or a Bayesian hypothesis testing method may be applied to the random number tester 1. Furthermore, a plurality of next-bit prediction units 12 corresponding to random number sequences for each operation condition may be used without combining the random number sequences generated for each operation condition into one.

Each of the above-described embodiments is an example for describing the present technology, and is not intended to limit the present technology only to these embodiments. The present technology can be implemented in various forms without departing from the gist thereof.

For example, in the methods disclosed in the present specification, steps, operations, or functions may be performed in parallel or in a different order as long as there is no inconsistency in the results. The described steps, operations, and functions are provided merely as examples, and some of the steps, operations, and functions may be omitted without departing from the gist of the present technology or may be combined and integrated, or another step, operation, or function may be added.

Furthermore, among the various embodiments disclosed herein, a certain feature (technical matter) in one embodiment can be, with appropriate improvement, added to another embodiment or replaced with a specific feature in the another embodiment, and such forms are also included in the gist of the present technology.

Furthermore, the present technology may include the following technical matters.

(1)

A random number tester that conducts a random number test on a random number generator on the basis of a pseudorandom number sequence generated by the random number generator, the random number tester including
a register unit that stores a pseudorandom number sequence generated by the random number generator,
a next-bit prediction unit that performs machine learning in a learning mode so as to receive a bit string in of m bits (m is an integer of 2 or more) in the pseudorandom number sequence stored in the register unit as an input, and, according to a predetermined machine learning algorithm, output one m−k-bit (k is a number of −1 or more and less than m) bit string out from among a 2^{m-k} number of candidates, each of which including a 1-bit predicted next bit pred, and
a matching probability determination unit that, in a test mode, calculates a matching probability on the basis of a next bit nxt following an m-bit bit string in in a pseudorandom number sequence generated by the random number generator and of a predicted next bit pred output from a trained the next-bit prediction unit subjected to the machine learning, and makes a pass/fail determination on a random number test on the basis of the matching probability that is calculated,
in which, in the learning mode, the next-bit prediction unit performs the machine learning so as to output one m−k-bit bit string out from among the 2^{m-k} number of candidates, with an m-bit bit string in as input data, and with an output obtained by connecting a next bit nxt of the bit string in to a later m−k−1 bit in the bit string in as ground-truth data.

(2)

The random number tester according to (1),
in which, in the test mode, the trained next-bit prediction unit receives, as an input, the bit string in in the pseudorandom number sequence generated by the random number generator, outputs one m−k-bit bit string out from among a 2^{m-k} number of candidates, each of which including a predicted next bit pred, and outputs the predicted next bit pred included in the output the one bit string out.

(3)
The random number tester according to (2),
in which, from among the 2^{m-k} number of bit strings out, the trained next-bit prediction unit identifies, as the one bit string out, a bit string out having a statistical property most similar to a statistical property of the input bit string in.

(4)

The random number tester according to (3),
in which the trained next-bit prediction unit outputs, as the predicted next bit pred, 1 bit following the predetermined bit string in the one bit string out.

(5)

The random number tester according to any one of (1) to (4), the random number tester further including a control unit including a training data quantity decision unit that decides a training data quantity on the basis of a sample quantity calculated on the basis of a population rate, a reliability, and an error,
in which, in the learning mode, the control unit controls the random number generator so as to generate the pseudorandom number sequence corresponding to the training data quantity that is decided.

(6)

The random number tester according to (5),
in which the training data quantity decision unit calculates an upper limit value of a training data quantity on the basis of the sample quantity, and decides the training data quantity from between a predetermined lower limit value and the upper limit value that is calculated.

(7)

The random number tester according to (5) or (6),
in which the matching probability determination unit calculates the matching probability on the basis of the number of matches between the next bit nxt and the predicted next bit pred, and of the training data quantity.

(8)

The random number tester according to (7),
in which the matching probability determination unit makes a pass/fail determination on the random number test according to whether or not calculated the matching probability is within a predetermined range.

(9)

The random number tester according to any one of (1) to (8),
in which the next-bit prediction unit includes a plurality of neural network models, and
in the learning mode, each of the plurality of neural network models receives, as inputs, bit strings in in the pseudorandom number sequence, the bit strings in being shifted each other by 1 bit, and performs the machine learning.

(10)

The random number tester according to any one of (1) to (9), the random number tester further including an action selection unit including an action selection table defining an expected value of a conditional probability,
in which, in the test mode, the action selection unit outputs a corrected predicted next bit pred to the matching probability determination unit according to the action selection table on the basis of the predicted next bit pred output by the trained next-bit prediction unit.

(11)

The random number tester according to (10),
in which the action selection unit updates an expected value of the conditional probability in the action selection table according to a predetermined bit in the pseudorandom number sequence.

(12)

The random number tester according to any one of (1) to (11),
in which, in the test mode, the trained next-bit prediction unit outputs the predicted next bit pred with respect to the pseudorandom number sequence corresponding to a test data quantity decided on the basis of a predetermined Bayesian hypothesis testing method.

(13)

The random number tester according to (12),
in which the matching probability determination unit calculates a Bayes' factor on the basis of the matching probability that is calculated, and decides the test data quantity on the basis of the Bayes' factor that is calculated.

(14)

The random number tester according to any one of (1) to (13), the random number tester further including a plurality of the next-bit prediction units that performs the machine learning on a pseudorandom number sequence generated by the random number generator for each predetermined key value,
in which, in the test mode, each of trained the plurality of next-bit prediction units subjected to the machine learning outputs a predicted next bit pred with respect to the pseudorandom number sequence generated by the random number generator according to corresponding the predetermined key value.

(15)

The random number tester according to (14), the random number tester further including a predicted next bit decision unit that decides one predicted next bit pred on the basis of a predicted next bit pred output by each of the plurality of next-bit prediction units.

(16)

The random number tester according to any one of (1) to (15),
in which the next-bit prediction unit performs the machine learning on one pseudorandom number sequence obtained by combining pseudorandom number sequences generated by the random number generator for each predetermined key value.

(17)

The random number tester according to any one of (1) to (16),
in which the next-bit prediction unit performs the machine learning on one pseudorandom number sequence obtained by combining pseudorandom number sequences generated by the random number generator for each predetermined operation condition.

(18)

The random number tester according to any one (1) to (17),
in which the trained next-bit prediction unit includes a plurality of binary logic circuits that outputs a predetermined logical value with respect to a predetermined input according to a predetermined truth table.

(19)

A random number testing method for conducting a random number test on a random number generator on the basis of a pseudorandom number sequence generated by the random number generator, the random number testing method including
storing, in a register unit, a pseudorandom number sequence generated by the random number generator,
performing control to enable operation in the learning mode, and
performing, by a next-bit prediction unit, machine learning in the learning mode according to a predetermined machine learning algorithm so as to receive a bit string in of m bits (m is an integer of 2 or more) in the pseudorandom number sequence stored in the register unit as an input, and, according to a predetermined machine learning algorithm, output one m−k-bit (k is a number of −1 or more and less than m) bit string out from among a 2^{m-k} number of candidates, each of which including a predicted next bit pred,
in which performing the machine learning including performing machine learning so as to output one m−k-bit bit string out from among the 2^{m-k} number of candidates, with an m-bit bit string in as input data, and with an output obtained by connecting a next bit nxt of the bit string in to a later m−k−1 bit in the bit string in as ground-truth data.

(20)

The random number testing method according to (19), the random number testing method further including
performing control to enable operation in a test mode after the machine learning is performed, and
in the test mode, calculating a matching probability on the basis of a next bit nxt following an m-bit bit string in in a pseudorandom number sequence generated by the random number generator and of a predicted next bit pred output from a trained next-bit prediction unit subjected to the machine learning, and making a pass/fail determination on a random number test on the basis of the matching probability that is calculated.

### REFERENCE SIGNS LIST

1 Random number tester
2 Random number generator
11 Register unit
111 Shift register
12 Next-bit prediction unit
13 Control unit
131 Sample quantity calculation unit
132 Training data quantity decision unit
14, 14′ Matching probability determination unit
141 Comparison unit
142 First counter
143 Second counter
144 Determination unit
145 Bayesian hypothesis testing unit
15 Action selection unit
151 Action selection table
16 Predicted next bit decision unit

1. A random number tester that conducts a random number test on a random number generator on a basis of a pseudorandom number sequence generated by the random number generator, the random number tester comprising:
a register unit that stores a pseudorandom number sequence generated by the random number generator;
a next-bit prediction unit that performs machine learning in a learning mode so as to receive a bit string in of m bits (m is an integer of 2 or more) in the pseudorandom number sequence stored in the register unit as an input, and, according to a predetermined machine learning algorithm, output one m−k-bit (k is a number of −1 or more and less than m) bit string out from among a 2^{m-k} number of candidates, each of which including a 1-bit predicted next bit pred; and
a matching probability determination unit that, in a test mode, calculates a matching probability on a basis of a next bit nxt following an m-bit bit string in in a pseudorandom number sequence generated by the random number generator and of a predicted next bit pred output from a trained the next-bit prediction unit subjected to the machine learning, and makes a pass/fail determination on a random number test on a basis of the matching probability that is calculated,
wherein, in the learning mode, the next-bit prediction unit performs the machine learning so as to output one m−k-bit bit string out from among the 2^{m-k} number of candidates, with an m-bit bit string in as input data, and with an output obtained by connecting a next bit nxt of the bit string in to a later m−k−1 bit in the bit string in as ground-truth data.

2. The random number tester according to claim 1,
wherein, in the test mode, the trained next-bit prediction unit receives, as an input, the bit string in in the pseudorandom number sequence generated by the random number generator, outputs one m−k-bit bit string out from among a 2^{m-k} number of candidates, each of which including a predicted next bit pred, and outputs the predicted next bit pred included in the output the one bit string out.

3. The random number tester according to claim 2,
wherein, from among the 2^{m-k} number of bit strings out, the trained next-bit prediction unit identifies, as the one bit string out, a bit string out having a statistical property most similar to a statistical property of the input bit string in.

4. The random number tester according to claim 3,
wherein the trained next-bit prediction unit outputs, as the predicted next bit pred, 1 bit following the predetermined bit string in the one bit string out.

5. The random number tester according to claim 1, the random number tester further comprising a control unit including a training data quantity decision unit that decides a training data quantity on a basis of a sample quantity calculated on a basis of a population rate, a reliability, and an error,
wherein, in the learning mode, the control unit controls the random number generator so as to generate the pseudorandom number sequence corresponding to the training data quantity that is decided.

6. The random number tester according to claim 5,
wherein the training data quantity decision unit calculates an upper limit value of a training data quantity on a basis of the sample quantity, and decides the training data quantity from between a predetermined lower limit value and the upper limit value that is calculated.

7. The random number tester according to claim 5,
wherein the matching probability determination unit calculates the matching probability on a basis of the number of matches between the next bit nxt and the predicted next bit pred, and of the training data quantity.

8. The random number tester according to claim 7,
wherein the matching probability determination unit makes a pass/fail determination on the random number test according to whether or not calculated the matching probability is within a predetermined range.

9. The random number tester according to claim 1,
wherein the next-bit prediction unit includes a plurality of neural network models, and
in the learning mode, each of the plurality of neural network models receives, as inputs, bit strings in in the pseudorandom number sequence, the bit strings in being shifted each other by 1 bit, and performs the machine learning.

10. The random number tester according to claim 1, the random number tester further comprising an action selection unit including an action selection table defining an expected value of a conditional probability,
wherein, in the test mode, the action selection unit outputs a corrected predicted next bit pred to the matching probability determination unit according to the action selection table on a basis of the predicted next bit pred output by the trained next-bit prediction unit.

11. The random number tester according to claim 10,
wherein the action selection unit updates an expected value of the conditional probability in the action selection table according to a predetermined bit in the pseudorandom number sequence.

12. The random number tester according to claim 1,
wherein, in the test mode, the trained next-bit prediction unit outputs the predicted next bit pred with respect to the pseudorandom number sequence corresponding to a test data quantity decided on a basis of a predetermined Bayesian hypothesis testing method.

13. The random number tester according to claim 12,
wherein the matching probability determination unit calculates a Bayes' factor on a basis of the matching probability that is calculated, and decides the test data quantity on a basis of the Bayes' factor that is calculated.

14. The random number tester according to claim 1, the random number tester further comprising a plurality of the next-bit prediction units that performs the machine learning on a pseudorandom number sequence generated by the random number generator for each predetermined key value,
wherein, in the test mode, each of trained the plurality of next-bit prediction units subjected to the machine learning outputs a predicted next bit pred with respect to the pseudorandom number sequence generated by the random number generator according to corresponding the predetermined key value.

15. The random number tester according to claim 14, the random number tester further comprising a predicted next bit decision unit that decides one predicted next bit pred on a basis of a predicted next bit pred output by each of the plurality of next-bit prediction units.

16. The random number tester according to claim 1,
wherein the next-bit prediction unit performs the machine learning on one pseudorandom number sequence obtained by combining pseudorandom number sequences generated by the random number generator for each predetermined key value.

17. The random number tester according to claim 1,
wherein the next-bit prediction unit performs the machine learning on one pseudorandom number sequence obtained by combining pseudorandom number sequences generated by the random number generator for each predetermined operation condition.

18. The random number tester according to claim 1,
wherein the trained next-bit prediction unit includes a plurality of binary logic circuits that outputs a predetermined logical value with respect to a predetermined input according to a predetermined truth table.

19. A random number testing method for conducting a random number test on a random number generator on a basis of a pseudorandom number sequence generated by the random number generator, the random number testing method comprising:
storing, in a register unit, a pseudorandom number sequence generated by the random number generator;
performing control to enable operation in the learning mode; and
performing, by a next-bit prediction unit, machine learning in the learning mode according to a predetermined machine learning algorithm so as to receive a bit string in of m bits (m is an integer of 2 or more) in the pseudorandom number sequence stored in the register unit as an input, and, according to a predetermined machine learning algorithm, output one m−k-bit (k is a number of −1 or more and less than m) bit string out from among a 2^{m-k} number of candidates, each of which including a predicted next bit pred,
wherein performing the machine learning including performing machine learning so as to output one m−k-bit bit string out from among the 2^{m-k} number of candidates, with an m-bit (m is an integer of 2 or more) bit string in as input data, and with an output obtained by connecting a next bit nxt of the bit string in to a later m−k−1 bit in the bit string in as ground-truth data.

20. The random number testing method according to claim 19, the random number testing method further comprising:
performing control to enable operation in a test mode after the machine learning is performed; and
in the test mode, calculating a matching probability on a basis of a next bit nxt following an m-bit bit string in in a pseudorandom number sequence generated by the random number generator and of a predicted next bit pred output from a trained next-bit prediction unit subjected to the machine learning, and making a pass/fail determination on a random number test on a basis of the matching probability that is calculated.
